(19) United States
(12) Patent Application Publication
(10) Pub. No.: US 2014/0070656 A1
(43) Pub. Date: Mar. 13, 2014

(54) MAGNET ALTERNATOR ASSEMBLY

(71) Applicant: Abraham Edquiban Ballena, Sacramento, CA (US)

(72) Inventor: Abraham Edquiban Ballena, Sacramento, CA (US)

(21) Appl. No.: 14/023,146

(22) Filed: Sep. 10, 2013

Related U.S. Application Data
(60) Provisional application No. 61/743,824, filed on Sep. 12, 2012.

(51) Int. Cl. H02K 3/48; H02K 15/085; H02K 15/00

(52) U.S. Cl. CPC H02K 3/48; H02K 15/0006; H02K 15/085
USPC 310/208; 29/593

(57) ABSTRACT

An alternator assembly including a stator disk having at least one slot positioned around a circumference of the stator disk. The slot functions to accommodate a removable stator coil spool. The stator coil spool is inserted into and extracted out from the stator disk through the slot.

### RELATED APPLICATIONS

This application claims the benefit of U.S. Provisional Application Ser. No. 61/743,824 filed Sep. 12, 2012, entitled, “Permanent magnet alternator with stator disk with external slots and removable stator coils in spools”, the entire content of which is incorporated herein by reference.

### FIELD OF THE INVENTION

The present invention relates to magnet alternators and, more particularly, to a permanent magnet alternator with a stator disk having removable stator coils wound.

### BACKGROUND OF THE INVENTION

In recent years, interest in renewable energy in the form of wind turbines and human-powered devices has increased dramatically, spawning myriads of designs in alternators. One such alternator is a permanent magnet alternator. Typically, there are two types of permanent magnet alternators, such as axial flux type and radial flux type alternators. A radial flux alternator usually has cylindrical rotors with a plurality of magnets around its surface facing a stator assembly in a cylindrical housing enclosing the rotor assembly. The stator assembly has a plurality of coils or windings facing the rotor that are permanently affixed to the stator assembly. Axial flux alternators usually have a disk-type rotor and a disk-type stator, and they are positioned proximately facing each other. Many permanent magnets are positioned in the rotor disk in annular disposition in its surface. The stator contains a plurality of coils or windings in annular disposition permanently affixed around the stator disk. Some stators contain individual built-in bobbins onto which the coils may be wound.

Currently, when stator coils of the alternators are damaged, it usually requires the opening or disassembling of the alternator assembly in order to access and repair the stator coil. Since the stator coils are usually wound in the stator disk in a continuous and complex manner, it requires replacing the whole coil. Such a task is very complicated, tedious and costly. In some versions of these alternators, the windings or coils are in the rotor and the magnets are in the stator. In such configuration, slip rings and brushes are required to take the induced voltage from the rotor in order to fix the coils. As such, it is very costly and time consuming to fix the alternators in the current art.

### SUMMARY OF THE INVENTION

Accordingly, an embodiment of the present invention provides a simple and efficient alternator, which is not only easy to build but is also easy to maintain and fix as well.

In one embodiment, stator coils in coil spools may be easily removed from the slot of the stator disk. The removable stator coils (also referred to as removable stator coil spools) may be replaced by new stator coils without opening or disassembling the alternator assembly.

In another embodiment, the new removable stator coil spools may be easily inserted into a stator disk. The removable stator coil spools may be replaced by new removable stator coil spools without opening or disassembling the alternator assembly.

As such, the embodiments of the present invention provide an improved magnet alternator assembly. In one embodiment, the magnet alternator assembly includes a stator disk having at least one slot positioned around a circumference of the stator disk. The slot functions to accommodate a removable stator coil spool (e.g., a spool with a plurality of individual stator coils wound onto the spool). The removable stator coil spool may be inserted into and extracted out from the stator disk via the slot.

### BRIEF DESCRIPTION OF THE DRAWINGS

FIG. 1 is a schematic view of a magnet alternator assembly in accordance with one embodiment of the present invention;

FIG. 2 is a perspective view of a stator disk of the magnet alternator assembly of FIG. 1 in accordance with one embodiment of the present invention;

FIG. 3 is a top view of the stator disk of FIG. 2 in accordance with one embodiment of the present invention;

FIG. 4A is a perspective view of a removable stator coil spool of FIG. 1 in accordance with one embodiment of the present invention;

FIG. 4B is a sectional front view of the stator disk of FIG. 2 with the removable coil stator coil spool of FIG. 4A in accordance with one embodiment of the present invention;

FIG. 5A is a top view of an outward side of the rotor disk of FIG. 1 in accordance with one embodiment;

FIG. 5B is a top view of an inward side of the rotor disk of FIG. 1 in accordance with one embodiment;

FIG. 6A is an exploded perspective view of a rotor assembly including the rotor disks of FIG. 1 in accordance with one embodiment;

FIG. 6B is a perspective view of an inward side of the rotor disk of FIG. 6A in accordance with one embodiment;

FIG. 6C is a perspective view of a compound spacer of the rotor assembly of FIG. 6A in accordance with one embodiment;

FIG. 7 is a schematic view of a magnet alternator assembly in accordance with one embodiment;

FIG. 8 is a sectional top view of the magnet alternator assembly of FIG. 7 in accordance with one embodiment; and

FIG. 9 is a flow chart illustrating a method for repairing the magnet alternator assembly in accordance with an embodiment of the present invention.

### DETAILED DESCRIPTION OF THE INVENTION

The present invention provides an improved magnet alternator assembly. In one embodiment, the improved magnet alternator assembly is for a wind turbine. Alternatively, the alternator assembly may be used in a motor, a generator, a water turbine, and so forth. The magnet alternator assembly includes a stator disk having a plurality of slots positioned around an outer boundary of the stator disk. Each of the slots is configured to accommodate a removable stator coil spool. Further, each of the slots includes an opening such that the removable stator coil spool may protrude from the opening, or may be inserted into the opening.

Accordingly, the magnet alternator assembly of the present invention does not require opening or disassembling the alternator assembly in order to access and test the stator coil spool. The coils in the stator coil spool may be easily tested via the opening without having to remove the spool from the slot. In addition, the stator coil spool may be easily inserted and extracted from the stator disk via the slot. As such, the stator coil spool may be replaced with a new stator coil spool without opening or disassembling the alternator assembly. Therefore, the magnet alternator assembly provides a simple and efficient configuration to assemble, maintain and repair the alternators.

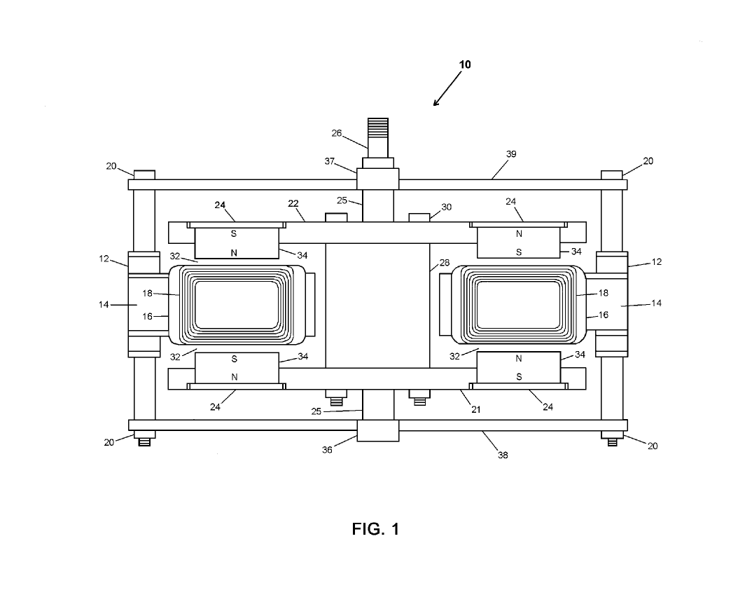

Referring to FIG. 1, there is illustrated a schematic view of a magnet alternator assembly (hereinafter “alternator assembly”) 10 in accordance with an embodiment of the present invention. The alternator assembly 10 includes a single stator disk 12 sandwiched between two rotor disks 21 and 22. The stator disk 12 has a plurality of external slots 14 in annular disposition around the circular perimeter of the stator disk 12. A compound shaft spacer 28 connects the two rotor disks 21 and 22. The two rotor disks 21 and 22 include a plurality of permanent magnets 34 arranged in annular disposition around the surface of the disks such that the magnets with opposite polarity are facing each other.

A removable stator coil spool (hereinafter “removable spool”) 16 having stator coils 18 wound in the removable spool 16 is placed inside the stator disk 12. The removable spool 16 is electrically connected to the stator disk 12. The stator coil 18 is made of materials including but not limited to copper, aluminum or other electrically conducting materials. Specifically, the removable spool 16 is placed inside the external slot 14 of the stator disk 12. In one embodiment, the removable spool 16 is removable from the external slot 14 of the alternator assembly 10. In one embodiment, two or more removable spools 16 are placed inside the external slot 14. In one embodiment, the stator coils 18 in the removable spool 16 are positioned inside the stator disk 12 so that magnets 34 of the two rotors disks 21 and 22 facing each other pass the magnetic field through the stator coils 18 at opposite sides simultaneously, thereby enhancing the amount of electrical energy induce from the magnetic coils. An air gap 32 is provided between the magnets 34 and the stator coil 18 to prevent the magnets 34 and the stator coil 18 from touching each other. In one embodiment, the air gap is set to be as small as possible without the risk of the stator coils 18 and the magnets 34 touching each other.

The alternator assembly 10 further includes housing covers 38 and 39, which are positioned at opposite sides of the alternator assembly 10. In one embodiment, the housing covers 38 and 39 are circular in shape. The housing covers 38 and 39 may include bearings 36 and 37 respectively at their center portion in order to accommodate a rotor shaft 26 as illustrated in FIG. 1. The alternator assembly 10 further includes through-bolts 20 that function to hold the alternator assembly 10 together. Specifically, the through-bolts 20 pass through the housing covers 38, 39, and the stator disk 12 to securely hold the alternator assembly together. The alternator assembly 10 further includes rotor shaft spacers 25, which function to keep proper distance between the rotor disk 21 and the housing cover 38 and between the rotor disk 22 and the housing cover 38.

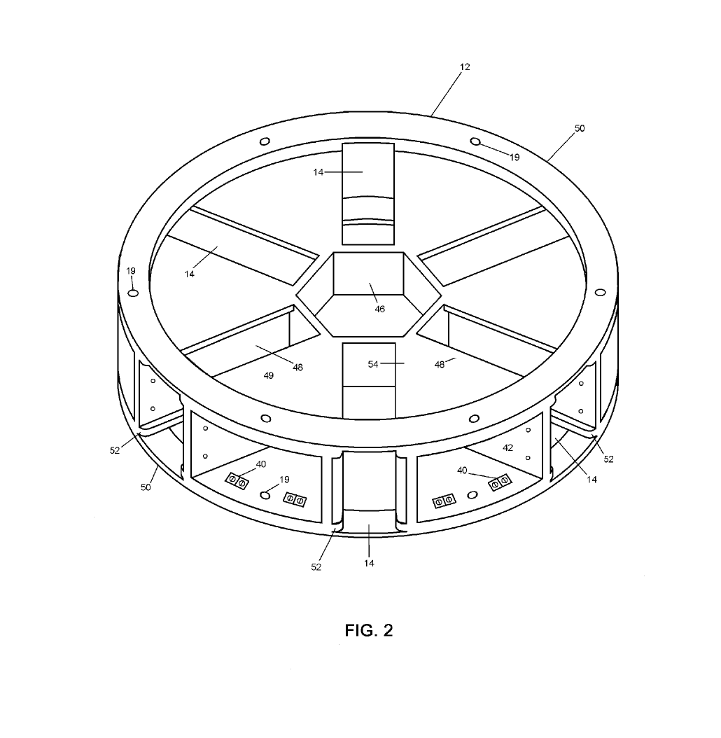

FIG. 2 illustrates a perspective view of a stator disk 12 of the alternator assembly 10 of FIG. 1 according to an embodiment of the present invention. The stator disk 12 includes two stator boards 54 positioned at opposite sides of each other. The stator boards 54 are stationary winding components that function to make the magnetic field inside the alternator assembly 10.

As shown, the two stator boards 54 may be circular in shape and a circular rim 50 is provided on each of the two stator boards 54. A vertical inner column 46 and a radial column 48 are provided to fully hold and support the two stator boards 54 together. Specifically, the vertical inner column 46 is positioned centrally between the stator boards 54 and extends vertically inside between the two stator boards 54. The radial column 48 extends radially between the two stator boards 54. A center hole 44 in the stator disk 12 is provided to accommodate the rotor shaft 26 along with the compound shaft spacer 28.

In one embodiment, a plurality of through-holes 19 are provided on the circular rim 50 of the stator disk 12 for insertion of through-bolts 20 in order to hold the alternator assembly 10 together. In one embodiment, a plurality of pinholes 42 are provided along the radial column 48 in order to pass lead wires (not shown) for the stator coil 18 in the removable spool 16. In one embodiment, pluralities of terminal blocks 40 are provided on the stator board 54 in order to provide for easy electrical connection of the lead wires for the removable spools 16 to the stator board 54. Although not shown, one of ordinary skill in the art will appreciate that other ways may be included to connect the lead wires.

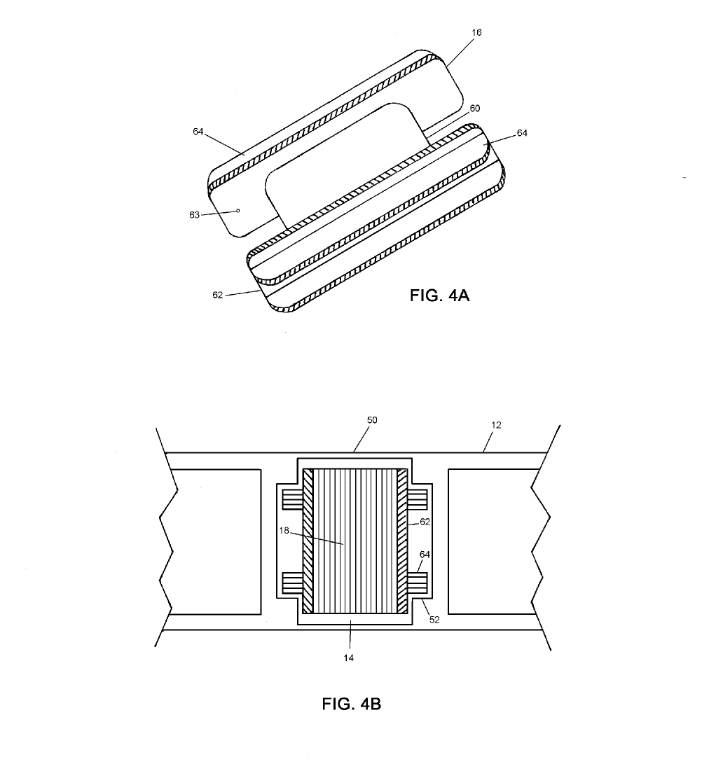

In one embodiment, the external slots 14 include openings 49 at opposite sides of the stator boards 54. The openings 49 may accommodate the removable spool 16 with the stator coil 18 in order to position the stator coil 18 proximate to the magnets 34. Each of the external slots 14 may include a ledge or track 52 for the removable spool 16 to slide in and out of the external slot 14 and to further securely hold the removable spool 16 inside the external slot as will be described in detail below with reference to FIGS. 4A and 4B.

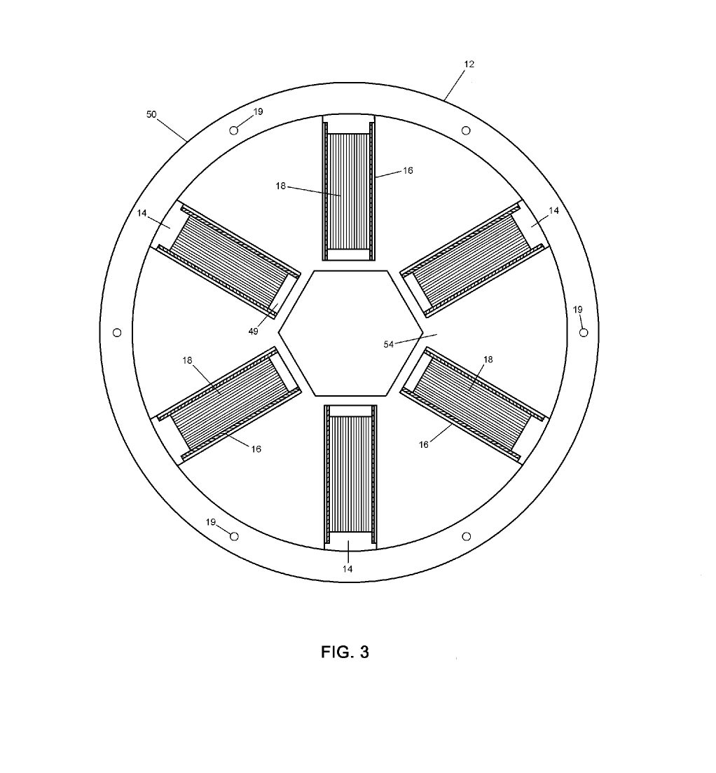

FIG. 3 shows a top view of the stator disk 12 of FIG. 2 according to an embodiment of the present invention. As shown, the stator coils 18 in the removable spools 16 are securely placed inside the external slots 14 of the stator disk 12.

FIG. 4A shows a perspective view of the removable spool 16 of FIG. 1 according to an embodiment of the present invention. The removable spool 16 includes a drum 60 and two rims 62 positioned opposite sides of the drum 60. The spool also includes a pair of flanges 64 at an outer side of the two rims 62. In one embodiment, a depth of the drum 60 in relation to the rim 62 determines the thickness of the stator coil 18 in the removable spool 16. The stator coil 18 is wound in the drum 60 so that the top of the stator coil 18 is flush with the top of the rim 62. However, the depth of the rims 62 in the horizontal length may be greater than the depth of the rims 62 in the vertical height in order to keep the coil from unraveling on its side. A pinhole 63 along the rim 62 is provided for wire leads (not shown) to pass through in order to electrically connect the stator coil 18 to the stator disk 12.

FIG. 4B shows a sectional front view of the stator disk 12 of FIG. 2 with the removable spool 16 of FIG. 4A shown inside the external slots 14. Specifically, the flanges 64 of the removable spools 16 are slid inside the external slot 14 in order to hold the removable spool 16 inside the external slot 14. In one embodiment, the flanges 64 of the removable spool 16 are adjusted in order to position the stator coils 18 to protrude from the opening 49 at the opposite sides of the stator boards 54 Adjustment of the position of the removable spool 16 in regards to the external slot 14 may be done during the manufacturing phase by adjusting the dimension of the external slot 14 or the removable spool 16 in relation to each other. Similarly, the ledges or tracks 52 in the external slots 14 may be adjusted in order to position the stator coils 18 to thrust outwards from the opening 49 at the opposite sides of the stator boards 54. A combination of the flanges 64 and the ledges or tracks 52 may be adjusted in order to position the stator coils 18 to protrude from the opening 49 at the opposite sides of the stator boards 54.

In one embodiment, one or more stator coils 18 in the removable spools 16 (or entire stator coil in the removable spools 16) are tested inside the stator disk 12 without opening or disassembling the alternator assembly 100. For example, individual stator coils 18 in the removable spools 16 protruding from the opening 49 may be easily tested from the outside of the stator disk 12 without removing the removable spools 16 from the external slot and further prevent the need for opening or disassembling the alternator assembly 100. The stator coils 18 are accessible from the outside via the opening 16 and so may be disconnected from their connection and tested with test meter without removing the removable spool 16 from the external slot 14.

In one embodiment, one or more stator coils 18 in the removable spools 16 are extracted out from the stator disk 12 without opening or disassembling the alternator assembly 100. Specifically, the one or more removable spools 16 may be easily extracted from the external slot 14 via the ledge or track 52. As an example, removable spool 16 are slide out of the external slot 14.

The one or more stator coils 18 may be damaged. In one embodiment, the one or more stator coils 18 are replaced with new stator coils. In another embodiment, a new magnet wire may be wound on the one or more stator coils 18. In another embodiment, the removable spool 16 may be removed and replaced with a new removable stator coil spool. Thus, stator coil spools may be an easily replaceable part in embodiments of the present invention.

In another embodiment, the stator coils 18 in the removable spools 16 are inserted back into the stator disk 12 without opening or disassembling the alternator assembly 10. Specifically, new removable stator coil spools may be easily inserted into the external slot 14 via the ledge or track 52 and electrically connected to the stator disk.

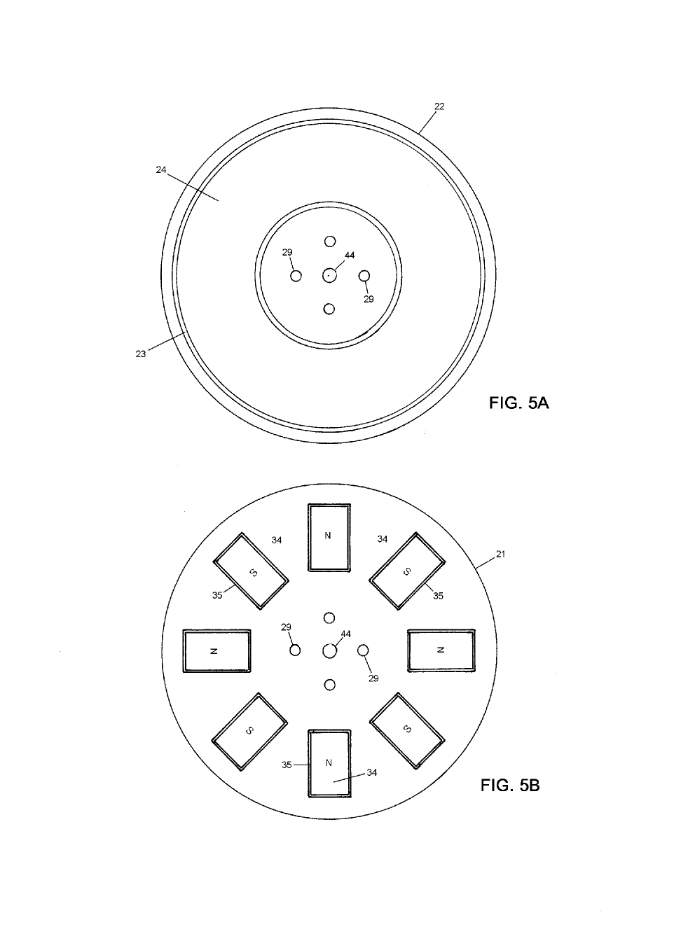

FIG. 5A illustrates a top view of the outward side of the rotor disk 22 of FIG. 1. As shown, the rotor disk 22 includes a backing plate 24 with a recess 23 around an outer rim of the backing plate 24. As shown, both the backing plate 24 and recess 23 are circular in shape in the illustrated embodiment. In one embodiment, the recess 23 is a shallow recess whose depth is roughly equal to the thickness of the backing plate 24. The backing plate 24 may be attached to the recess 23 in the rotor disk 22 by materials including but not limited to, adhesive, screws, latches, nuts, bolts, or other connectors. Although not shown, the magnets 34 may be placed on opposite side of the backing plate 24 of the rotor disk 22.

FIG. 5B illustrates a top view of an inward side of the rotor disk 21 of FIG. 1 positioned opposite to the rotor disk 21. As shown, the opposite side of the backing plate 24 of the rotor disk 21 has a plurality of slits 35 in annular disposition around the rotor disk 21 to hold the magnets 34 in place. In one embodiment, the backing plate 24 is made of magnetic metal to enhance the magnetic flux of the rotor assembly and to keep the magnets 34 in place. Magnets 34 on the two rotor disks 21 and 22 are arranged in alternating polarities around the circumference of the rotor disks 21, 22. In one embodiment, opposite magnets 34 of the two rotor disks 21 and 22 face each other in alternating polarity. Additionally, through-holes 29 are provided to allow the through-bolts 20 to go through the two rotor disks 21 and 22. As discussed above, the center hole 44 is provided to accommodate the rotor shaft along with the compound shaft spacer 28.

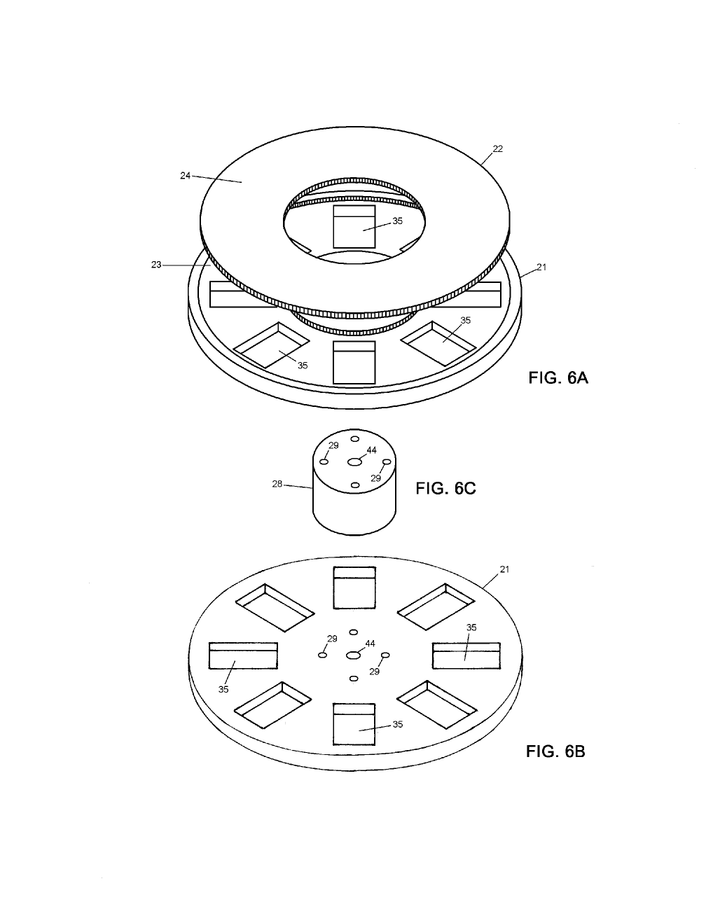

FIG. 6A illustrates a partial exploded outward side view of a rotor assembly including the two rotor disks 21 and 22 according to an embodiment of the present invention. As shown, the rotor disks 21 and 22 are positioned to directly face each other. The rotor disk 22 includes the backing plate 24 with the recess 23 around an outer rim of the backing plate 24. The rotor disk 21 includes the plurality of slits 35 in annual disposition around the rotor disk 21 to hold the magnets (not shown).

FIG. 6B illustrates a perspective view of inward side of the rotor disk 21 of FIG. 6A according to an embodiment of the present invention. As shown, the through-holes 29 are provided to allow through-bolts (not shown) to go through the two rotor disks 21 and 22. Furthermore, the center hole 44 is provided to accommodate the compound shaft spacer (not shown).

FIG. 6C illustrates the compound shaft spacer 28 used to connect the two rotor disks 21 and 22 of the rotor assembly of FIG. 6A according to one embodiment of the present invention. The compound shaft spacer 28 may provide for a firm and stable connection between the two rotor disks 21 and 22. In other embodiment, the two rotor disks 21 and 22 may be connected together by a bolt or a nut can also be used to connect the two rotor disks 21 and 22.

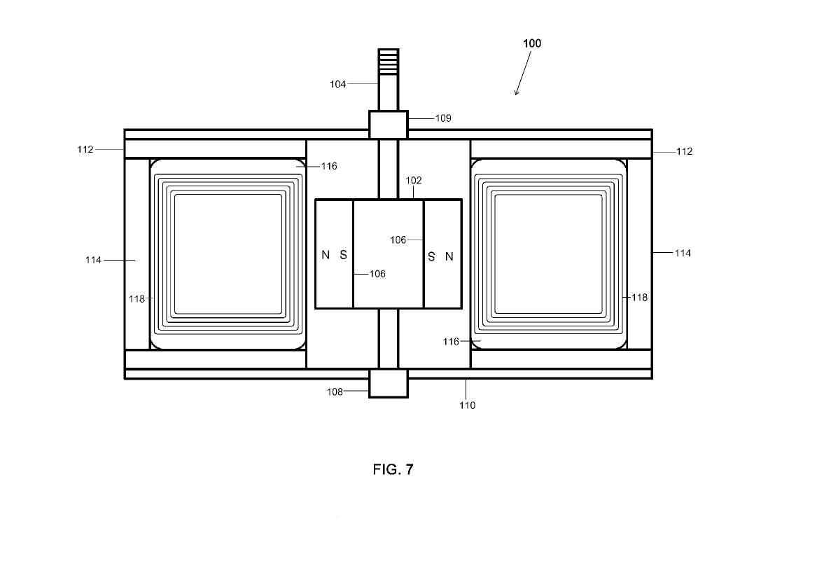

FIG. 7 is a schematic view of a magnet alternator assembly (hereinafter “alternator assembly”) 100 in accordance with another embodiment of the present invention. The alternator assembly 100 may utilize a radial flux type configuration as illustrated in FIG. 7. The alternator assembly 100 includes a rotor disk 102 including a plurality of permanent magnets 106 attached at an outward circumference of the rotor disk 102 and arranged in an annual disposition such that the magnets with opposite polarity are facing each other. The alternator assembly 100 also includes a stator housing 112 enclosing the rotor disk 102. The stator housing 112 has a plurality of external slots 114 in annular disposition around the stator housing 112. Individually removable stator coil spools (hereinafter “removable spools) 116 having stator coils 118 are inserted into the stator housing 112 through the external slots 114 so that magnets 106 of the rotors disk 102 facing each other pass the magnetic field through the stator coils 18 at opposite sides approximately simultaneously, thereby enhancing the amount of electrical energy induce from the magnetic coil. Covers 110 and 111 are provided at opposite sides of the alternator assembly 100. Additionally, the covers 110 and 111 include center bearings 108 and 109 respectively to accommodate a rotor shaft 104.

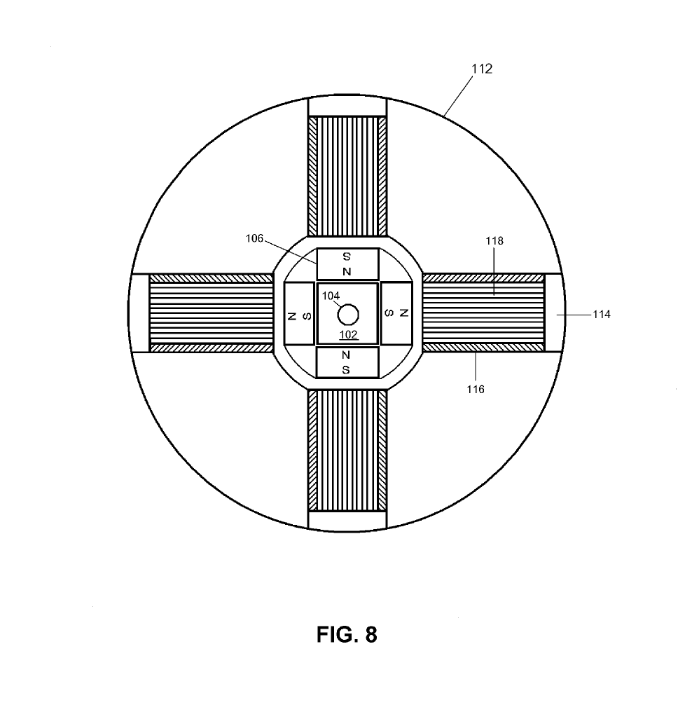

FIG. 8 illustrates a top sectional view of the alternator assembly 100 of FIG. 7 according to an embodiment of the present invention. As shown, the alternator assembly includes the rotor disk 102 having a plurality of permanent magnets 106 around an outward circumference of the rotor disk. The rotor disk 102 also includes the stator housing 112 with a plurality of external slots 114 in annular disposition around the stator housing. In addition, as shown, the individual removable spools 116 having the stator coils 118 are inserted into the external slots 114. Further, the rotor shaft 104 is accommodated at a center point of the rotor disk 102.

In one embodiment, while in operation, the rotor shaft 26 may be connected directly or by gear to a mechanical producing devices including but not limited to, wind turbines, water turbines or human-powered devices or other similar devices that produce electrical energy.

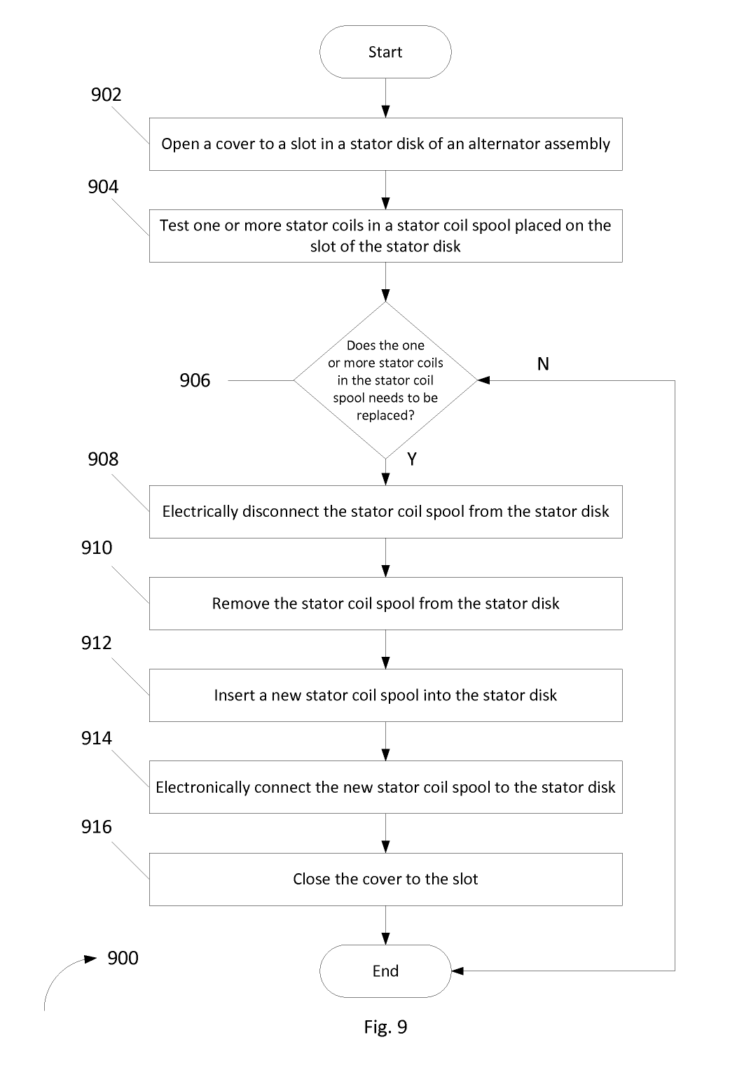

FIG. 9 is a flow chart illustrating a method 900 of repairing an alternator assembly in accordance with an embodiment of the present invention. In one embodiment, the alternator assembly is the alternator assembly 10 of FIG. 1. In another embodiment, the alternator assembly is the alternator assembly 100 of FIG. 7. The method 900 may be performed by a machine (e.g., by a robotic device having a robotic arm with a tester (e.g., a digital multimeter) and a hand capable of securing stator coil spools) or a person.

The method 900 begins at block 902, where a cover to a slot in a stator disk of the alternator assembly is opened. As an example, the cover is one of the housing covers 38 or 39 of FIG. 1. The slot may be the same as the external slot 14 of FIG. 1 and the stator disk may be the same as the stator disk 12 of FIG. 1. The slot includes a removable stator coil spool. At block 904, one or more stator coils in the stator coil spool (hereinafter “spool”) placed on the slot of the stator disk are tested. In one embodiment, the entire removable stator coil spool is tested as a single unit. As an example, the removable stator coil spool is same as the removable spool 16 of FIG. 1. In one embodiment, the one or more stator coils (or the entire removable stator coil spool) are tested via an opening in slot. As an example, the opening is same as the opening 49 of FIG. 1 and the spool protrudes from the opening.

At block 906, it is determined whether the one or more stator coils in the spool need to be replaced (e.g., if there is an open circuit detected or if electrical properties such as resistance, current leakage, etc. call outside of allowable thresholds). The method 900 ends when it is determined at block 906 that the removable stator coil spools do not need to be replaced. However, if at block 906, it is determined that the removable stator coil spool needs to be replaced, then at block 908, the removable stator coil spool in the slot is electrically disconnected from the stator disk of the alternator assembly. The stator disk may be same as the stator disk 12 of FIG. 1. At block 910, the removable stator coil spool is removed from stator disk. In one embodiment, the spool is removed by sliding the spool out of the slot (e.g., along a track in the slot). At block 912, a new removable stator coil spool is inserted into the stator disk. In one embodiment, the new removable stator coil spool is inserted by placing and sliding the new stator coil spool into the slot (e.g., along the track in the slot). At block 914, the new stator coil spool is electrically connected to the stator disk. At block 916, the cover to the slot is closed.

It will be understood that a person skilled in the art can appreciate that the alternator assembly of the present invention may be configured to be of one of a one phase or three phases or other multiple phases.

While the present invention has been described with respect to what are some embodiments of the invention, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation to encompass all such modifications and equivalent structures and functions.

1. An alternator assembly, comprising:
a stator disk comprising at least one slot positioned around a circumference of the stator disk, wherein the at least one slot accommodates a removable stator coil spool; and
the removable stator coil spool, inserted into the at least one slot, wherein the removable stator coil spool is electrically connected to the stator disk.

2. The alternator assembly of claim 1, further comprising a first rotor disk and a second rotor disk positioned across from the first rotor disk such that the first rotor disk faces the second rotor disk, wherein the stator disk is disposed between the first rotor disk and the second rotor disk.

3. The alternator assembly of claim 2, further comprising a first magnet having a first polarity positioned adjacent to the first rotor disk facing the stator disk and a second magnet having a second polarity positioned adjacent to the second rotor disk facing the stator disk, wherein the first polarity is opposite to the second polarity, wherein the first magnet and the second magnet pass through the magnetic field through the stator coils.

4. The alternator assembly of claim 1, wherein the stator disk comprises a first stator board and a second stator board, wherein the first stator board is positioned opposite to the second stator board.

5. The alternator assembly of claim 4, wherein the at least one slot is provided in at least one of the first stator board or the second stator board.

6. The alternator assembly of claim 5, wherein the at least one slot comprises a track to accommodate the removable stator coil spool to slide into the slot and to slide out of the slot.

7. The alternator assembly of claim 6, wherein the removable stator coil spool comprises a drum, two rims positioned at opposite sides of the drum, a pair of flanges at outer sides of the two rims, and a plurality of coils of wire wound around the drum.

8. The alternator assembly of claim 7, wherein the pair of flanges of the removable stator coil spool are configured to slide into the slot and secure the removable stator coil spool inside the slot.

9. The alternator assembly of claim 7, wherein the at least one slot comprises openings at opposite sides of the first and the second stator boards, wherein the openings accommodate the removable stator coil spool to position the removable stator coil spool proximate to a first magnet and a second magnet.

10. The alternator assembly of claim 9, wherein the removable stator coil spool protrudes from the openings at the opposite sides of the first and the second stator board.

11. The alternator assembly of claim 10, wherein at least one of the pair of the flanges of the removable stator coil spool or the track are adjusted to position the removable stator coil spool to protrude from the openings.

12. The alternator assembly of claim 1, wherein the removable stator coil spool is configured to be tested through the at least one slot without removal of the removable stator coil spool.

13. The alternator assembly of claim 1, wherein the removable stator coil spool is removable from the stator disk without opening or disassembling the alternator assembly.

14. The alternator assembly of claim 1, wherein the at least one slot comprises a plurality of slots distributed around the circumference of the stator disk, wherein each of the plurality of slots is configured to receive at least one removable stator coil spool.

15. A method of repairing an alternator assembly, the method comprising:
electrically testing a removable stator coil spool while the removable stator coil spool is disposed in a slot of a stator disk in the alternator assembly;
responsive to determining that the removable stator coil spool has failed a test, performing the following comprising:
electrically disconnecting the removable stator coil spool from the stator disk;
removing the removable stator coil spool from the stator disk via the slot;
inserting a new removable stator coil spool into the stator disk via the slot; and
electrically connecting the new removable stator coil spool to the stator disk.

16. The method of claim 15, wherein
removing the removable stator coil spool from the stator disk comprises sliding the removable stator coil spool out of the slot along a track in the slot; and
inserting the new removable stator coil spool into the stator disk comprises sliding the new removable stator coil spool into the slot along the track.

17. A removable stator coil spool, comprising:
a drum;
two rims positioned at opposite sides of the drum;
a pair of flanges at outer sides of the two rims, configured to secure the removable stator coil spool into a slot positioned at a circumference of a stator disk;
a plurality of coils of wire wound around the drum; and
wire connectors configured to electrically connect the plurality of coils of the removable stator coil spool to the stator disk.

18. The removable stator coil spool of claim 17 wherein the pair of the flanges are configured to slide inside an external slot of the stator disk.

19. The removable stator coil spool of claim 17 wherein the pair of flanges are adjusted to position the plurality of coils to protrude from an opening of the stator disk.

20. The removable stator coil spool of claim 17 wherein the removable stator coil spool is removable from the stator disk without opening or disassembling an alternator assembly.
